(19) United States
(12) Patent Application Publication
(10) Pub. No.: US 2015/0357763 A1
(43) Pub. Date: Dec. 10, 2015

(54) TERMINAL PANEL, ELECTRONIC APPLIANCE EQUIPPED WITH A TERMINAL PANEL AND SURFACE TREATMENT METHOD FOR AN ELECTONIC APPLIANCE

(71) Applicants: Takayuki OKAMOTO, Tokyo (JP); Yoshinobu MORIYA, Tokyo (JP); Susumu OGAWA, Tokyo (JP)

(72) Inventors: Takayuki OKAMOTO, Tokyo (JP); Yoshinobu MORIYA, Tokyo (JP); Susumu OGAWA, Tokyo (JP)

(21) Appl. No.: 14/759,215

(22) PCT Filed: Jan. 21, 2013
(86) PCT No.: PCT/JP2013/051063

§ 371 Date: Jul. 3, 2015

(51) Int. Cl. H01R 13/659

(52) U.S. Cl. CPC H01R 13/659

(57) ABSTRACT

The object of the present invention is to provide a terminal panel whose surface is unlikely to be scratched and which makes scuff marks inconspicuous. A terminal panel of the present invention includes: at least, one terminal into which a connector is inserted from the outside; and, a metal plate with the terminal attached thereto, having a plurality of recesses (7) formed on its surface.

### TECHNICAL FIELD

The present invention relates to a terminal panel for an electronic appliance, an electronic appliance and a surface treatment method for an electronic appliance.

### BACKGROUND ART

Electronic appliances such as projectors use a terminal panel with various connectors inserted therein as part of the exterior thereof. The terminal panel includes terminals to which connectors are inserted. The terminal panel uses a metal plate for the purpose of blocking unwanted radiation (EMI) and the like from the connectors and the interior of the electronic appliance thereof. However, this metal plate sometimes becomes scuffed during transportation of the projector. To deal with this, for example in Patent Document 1, the terminal panel is covered with a cover that is removable from the housing when the projector is not used, to thereby prevent damage to the terminal panel.

### RELATED ART DOCUMENTS

### Patent Documents

Patent Document 1: JP2000-19479A

### SUMMARY OF THE INVENTION

### Problem to be Solved by the Invention

However, since the metal plate is formed by a stamping process in order to form openings to enable attachment of terminals, there are cases in which the surface becomes scratched. Further, since the projector is not used at a regular place but is often used at different places, the connectors are frequently inserted and removed. Therefore, there is a risk that the areas around the terminals of the metal plate will become scuffed so that the appearance of the projector will be spoiled.

The object of the present invention is to provide a terminal panel on which scratches to the surface are unlikely to occur and on which scuff marks become inconspicuous, and to provide, as well, an electronic appliance that is equipped with a terminal panel, and a surface treatment method for an electronic appliance.

### Means that Solve the Problem

A terminal panel of the present invention includes: at least, one terminal into which a connector is inserted from the outside; and, a metal plate with the terminal attached thereto, having a plurality of recesses formed on the surface thereof.

An electronic appliance of the present invention is equipped with a terminal panel including: at least, one terminal into which a connector is inserted from the outside; and, a metal plate with the terminal attached thereto, having a plurality of recesses formed on the surface thereof.

A surface treatment method for an electronic appliance of the present invention includes a step of forming a plurality of recesses with a pitch of 0.8 mm to 2 mm on the surface of a metal plate to which a terminal is attached and into which a connector is inserted from the outside.

### BRIEF DESCRIPTION OF DRAWINGS

FIG. 1A A perspective appearance view of a projector.

FIG. 1B A schematic backside view of the projector in FIG. 1A.

FIG. 2 A schematic configurational view showing a state in which a terminal panel is covered with a protecting panel.

FIG. 3 An exploded schematic perspective view of a terminal panel.

FIG. 4 A schematic configurational view of a terminal panel.

FIG. 5A An enlarged view of a terminal panel.

FIG. 5B An enlarged sectional view cut along A-A in FIG. 5A.

FIG. 5C An enlarged view of part B in FIG. 5B.

FIG. 6 A view showing a layout pattern of other recesses.

### MODES THAT CARRY OUT THE INVENTION

Next, the embodiment of the present invention will be described with reference to the drawings. Though the terminal panel of the present invention can be used for general electronic appliances, the description hereinbelow will be given by using an example of a projector.

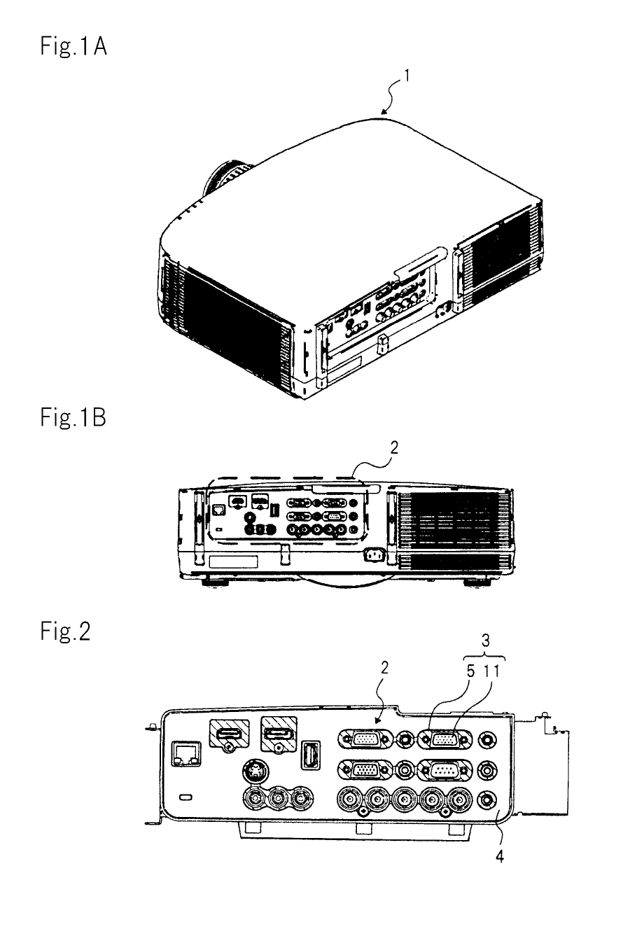

FIG. 1A is a perspective appearance view of a projector, and FIG. 1B is a schematic backside view of the projector in FIG. 1A.

Projector 1 modulates the luminous flux radiated from a light source in accordance with image information by a modulation element to form an image of light and to enlarge and project the formed image of light on a screen by means of a projecting lens.

The backside of projector 1 is provided with interface unit 2 including a plurality of terminals 11 into which connectors for conveying input signals from computers and the like, cables for conveying video signals, cables for conveying audio signals and the like are inserted.

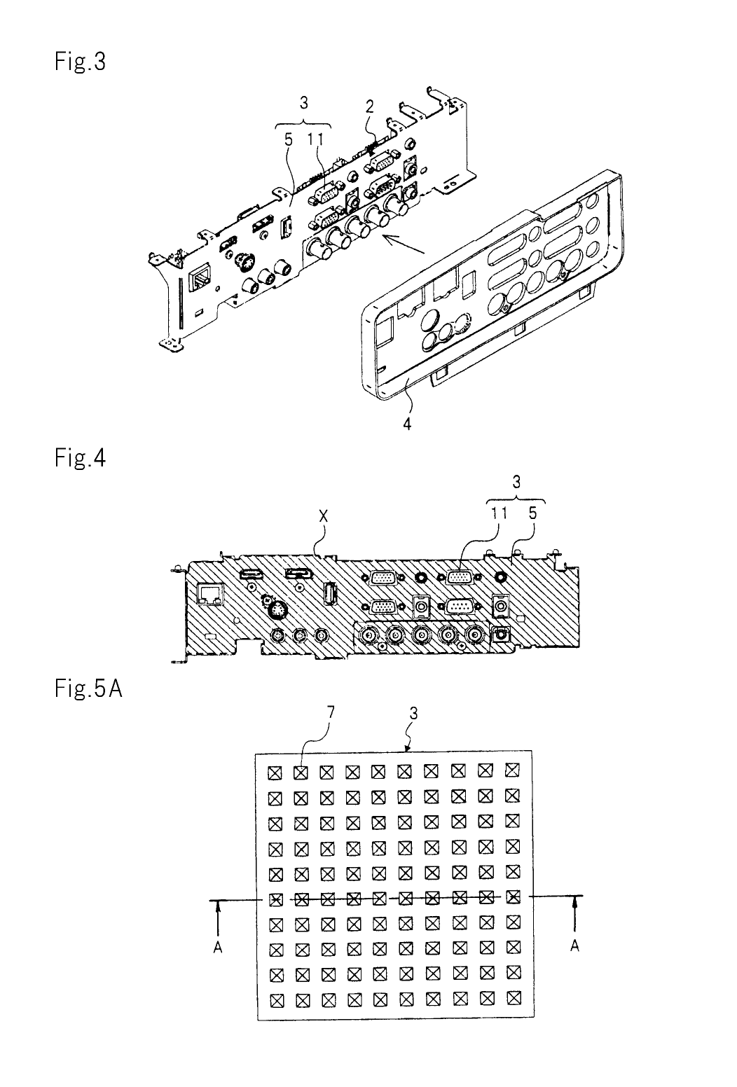

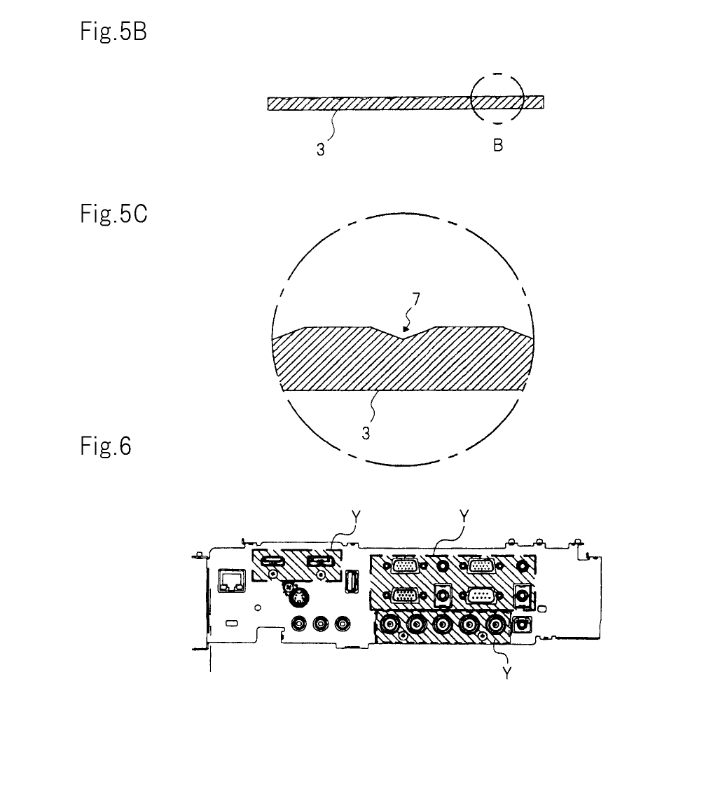

FIG. 2 shows a schematic configurational view of a state in which a terminal panel is covered with a protecting panel, FIG. 3 an exploded schematic perspective view of a terminal panel, and FIG. 4 a schematic configurational view of a terminal panel. FIG. 5A shows an enlarged view of a terminal panel, FIG. 5B, an enlarged sectional view cut along A-A in FIG. 5A, and FIG. 5C an enlarged view of part B in FIG. 5B.

Terminal panel 3 is formed of metal plate 5 of, for example an electro galvanized steel plate, aluminum alloy, cold-rolled stainless sheet or the like, to which a plurality of terminals 11 are attached. Further, a protecting panel 4 is disposed to cover terminal panel 3 such that terminals 11 are exposed, whereby this arrangement prevents the surface of terminal panel 1 from being damaged.

The surface of terminal panel 3 of the present invention is formed with a plurality of recesses 7 in the area other than terminals 11. Here, the hatched portion in FIG. 4 is the area formed with recesses 7. Plural recesses 7 are arranged two-dimensionally. Every recess 7 is a quadrangular pyramid with sides of 0.4 mm long and a depth of 0.2 mm and has the same shape. The recesses are arranged with a pitch of 0.5 mm. Herein, recesses 7 may be arranged matrix-wise. Recesses 7 are preferably arranged with a pitch of about 0.8 mm to 2 mm. The shape of each recess 7 is not limited to a quadrangular pyramid, but may be any shape such as a triangular pyramid, cone, or the like. The depth of recess 7 is preferably ⅕ to ½ of the thickness of metal plate 5 in view of the restrictions in working metal plate 5.

Because of formation of recess-forming section X with multiple recesses 7 on the surface of terminal panel 3 in the area other than terminals 11 in this way, if the user touches metal plate 5 of terminal panel 3 when a connecter from the outside is inserted into terminal 11, the hands will be prevented from coming into contact with the bottom of recesses 7 so that it is unlikely that fingerprints will be created. For example, even if a connector touches metal plate 5, it will be difficult for the connector to touch depressed recesses 7, with the result that is not likely that metal plate 5 will be damaged.

Further, the light incident on recess 7 is reflected in diverse directions. Accordingly, it is difficult to see part of the recess from the outside compared to viewing the area other than recess 7. That is, even if recesses 7 are scratched, the scuffs marks will not be conspicuous. As described above, the pitch between recesses 7 is preferably 0.8 mm to 2 mm. In this way, the pitch is large enough compared to the wavelength of light (visible light rays) so that light wave interference will not occur.

In metal plate 5 of terminal panel 3, openings are formed by stamping to enable terminals to be attached. Similarly, the pattern of recesses 7 can also be formed by stamping. Accordingly, it is possible to prevent an increase in cost. Further, during the inspection process, before products are shipped, connectors may be plugged into and unplugged from terminals 11. In this case, this configuration prevents metal plate 5 from being scratched, hence this makes it possible to improve production yield and to enhance quality.

Here, the pattern of recesses 7 does not need to be formed over all of metal plate 5. For example, as shown in FIG. 6, recess-forming sections Y may formed in the areas around the terminals for which connectors are frequently plugged and unplugged.

Although the present invention has been explained in detail with reference to the preferred exemplary embodiments, the present invention should not be limited to the above exemplary embodiment. Various changes and modifications can be made therein without departing from the spirit and scope of the present invention.

### DESCRIPTION OF REFERENCE NUMERALS

1 projector (electronic appliance)

2 interface unit

3 terminal panel

4 protecting panel

5 metal plate

7 recess

11 terminal

X, Y recess-forming section.

1. (canceled)

2. (canceled)

3. (canceled)

4. (canceled)

5. (canceled)

6. (canceled)

7. (canceled)

8. A terminal panel, comprising:
at least one terminal into which a connector is inserted from the outside; and
a metal plate with the terminal attached thereto, having a plurality of recesses formed on the surface thereof.

9. The terminal panel according to claim 8, wherein the plurality of recesses are formed with a predetermined pitch.

10. The terminal panel according to claim 9, wherein the pitch is specified to be 0.8 mm to 2 mm.

11. The terminal panel according to claim 8, wherein a depth of the plurality recesses is ⅕ to ½ of a thickness of the metal plate.

12. The terminal panel according to claim 9, wherein a depth of the plurality recesses is ⅕ to ½ of a thickness of the metal plate.

13. The terminal panel according to claim 10, wherein a depth of the plurality of recesses is ⅕ to ½ of a thickness of the metal plate.

14. The terminal panel according to claim 8, wherein the plurality of recesses are formed only around part of the terminals.

15. The terminal panel according to claim 9, wherein the plurality of recesses are formed only around part of the terminals.

16. The terminal panel according to claim 10, wherein the plurality of recesses are formed only around part of the terminals.

17. The terminal panel according to claim 11, wherein the plurality of recesses are formed only around part of the terminals.

18. The terminal panel according to claim 12, wherein the plurality of recesses are formed only around part of the terminals.

19. The terminal panel according to claim 13, wherein the plurality of recesses are formed only around part of the terminals.

20. An electronic appliance including a terminal panel according to claim 8.

21. An electronic appliance including a terminal panel according to claim 9.

22. An electronic appliance including a terminal panel according to claim 10.

23. An electronic appliance including a terminal panel according to claim 11.

24. An electronic appliance including a terminal panel according to claim 12.

25. An electronic appliance including a terminal panel according to claim 13.

26. An electronic appliance including a terminal panel according to claim 14.

27. An electronic appliance including a terminal panel according to claim 15.

28. A surface treatment method for an electronic appliance, comprising forming a plurality of recesses with a pitch of 0.8 mm to 2 mm on a surface of a metal plate to which a terminal is attached and into which a connector is inserted from the outside.
